(19) United States
(12) Patent Application Publication
(10) Pub. No.: US 2009/0300283 A1
(43) Pub. Date: Dec. 3, 2009

(54) Method and apparatus for dissolving hot spots in storage systems

(76) Inventor: Yutaka Kudo, San Jose, CA (US)

Correspondence Address: MATTINGLY & MALUR, P.C., 1800 DIAGONAL ROAD, SUITE 370, ALEXANDRIA, VA, 22314, US

(21) Appl. No.: 12/155,046

(22) Filed: May 29, 2008

(51) Int. Cl. G06F 12/00

(52) U.S. Cl. 711/114; 711/E12.001

(57) ABSTRACT

Hot spots in a storage system may be located and dissolved in a smallest feasible time. A particular volume can be selected to be migrated from a hot spot with a minimum workload, and the most appropriate destination for receiving the migration is identified prior to beginning the migration. A management computer may monitor the load of each array group in the storage system in order to detect hot spots, and calculate estimated migration times for selecting a volume to be migrated from a hot spot according to shortest estimated time. Furthermore, because the storage controller needs to re-write data that is updated in an already-migrated area by a host computer during the migration, choosing the smallest volume is not the only consideration taken into account. Write access rates by host computers to the volume be migrated are taken into consideration when determining a candidate for migration.

### BACKGROUND OF THE INVENTION

According to recent trends, storage systems may be implemented with a large number of hard disk drives (HDDs), which are configured to provide the data volumes used by host computers for data storage, or the like. In such arrangements, there may arise a situation in which data accesses from multiple host computers are concentrated on the same HDD or same array of HDDs in the storage system, and this can cause what is known as a “hot spot” in the storage system. Generally, a hot spot means that a certain portion of the storage system is too busy, while other portions of the storage system are not so busy. Hot spots can cause performance problems, such as delayed response times to the host computers, and, in a worst-case scenario, may cause data to be corrupted or lost.

Because a hot spot can be defined as a heavily-loaded area in the storage system, the volumes located at the hot spot cannot be easily migrated to other areas in the storage system because the migration will increase the load even further. However, because the hot spot needs to be dissolved to improve performance, it is necessary to carry out the migration of one or more volumes from the hot spot area to another less busy area of the storage system, and it is desirable to dissolve the hot spot as quickly as possible. One problem associated with this procedure is selecting which volume in the hot spot should be migrated to the less busy area. Factors that should be taken into consideration when selecting the volume to be migrated include volume capacity and volume busy rate. Generally, the smaller size of the volume to be transferred, the shorter the migration time. Also, the lower the busy rate, the shorter the migration time. As a practical matter, the host computer will probably make write accesses (data updates) to the volume being migrated during the migration process. Accordingly, the migration method should at least take into account both the size of the volume and the busy rate of the volume.

Related art includes US Patent Application Publication No. US2007/0118710, to Hiroshi Yamakawa et al., entitled “Storage System and Data Migration Method” and US Patent Application Publication No. US2007/0255922, to Naotsugu Toume et al., entitled “Storage Resource Management System, Method, and Computer”, the entire disclosures of which are incorporated herein by reference.

### BRIEF SUMMARY OF THE INVENTION

Exemplary embodiments of the invention are directed to a technology capable of dissolving hot spots in a storage system by data migration. Exemplary embodiments of the invention provide for selecting a volume for migration from an identified hot spot, while minimizing the associated migration work load, and also provide techniques for choosing an appropriate destination for the migration. These and other features and advantages of the present invention will become apparent to those of ordinary skill in the art in view of the following detailed description of the preferred embodiments.

### BRIEF DESCRIPTION OF THE DRAWINGS

The accompanying drawings, in conjunction with the general description given above, and the detailed description of the preferred embodiments given below, serve to illustrate and explain the principles of the preferred embodiments of the best mode of the invention presently contemplated.

FIG. 1 illustrates an example of a hardware and logical configuration in which the method and apparatus of the invention may be applied.

FIG. 2 illustrates an exemplary data structure of a storage configuration table.

FIG. 3 illustrates an exemplary data structure of a LU-LDEV mapping table.

FIG. 4 illustrates an exemplary conceptual diagram of write access by a host computer during migration.

FIG. 5 illustrates an exemplary chart of the probabilities of data writes to a copied area corresponding to the size of a copied area.

FIG. 6 illustrates an exemplary data structure of a copy speed vs. busy rate table.

FIG. 7 illustrates an exemplary data structure of a migration time estimation table.

FIGS. 8A-8B illustrate exemplary data structures of job management tables.

FIG. 9 illustrates an exemplary flowchart of a process for volume migration scheduling in exemplary embodiments of the present invention.

FIG. 10 illustrates an exemplary flowchart of a process for finding a hot spot array group that needs to be dissolved by migration.

FIG. 11 illustrates an exemplary flowchart of a process for creating a migration time estimation table for the source (hot spot) array group.

FIG. 12 illustrates an exemplary flowchart of a process for selecting a destination array group.

FIG. 13 illustrates an exemplary flowchart of a process for carrying out migration job management and execution in exemplary embodiments of the present invention

FIG. 14 illustrates an exemplary data structure of a migration setting table.

### DETAILED DESCRIPTION OF THE INVENTION

In the following detailed description of the invention, reference is made to the accompanying drawings which form a part of the disclosure, and in which are shown by way of illustration, and not of limitation, exemplary embodiments by which the invention may be practiced. In the drawings, like numerals describe substantially similar components throughout the several views. Further, it should be noted that while the detailed description provides various exemplary embodiments, as described below and as illustrated in the drawings, the present invention is not limited to the embodiments described and illustrated herein, but can extend to other embodiments, as would be known or as would become known to those skilled in the art. Reference in the specification to “one embodiment” or “this embodiment” means that a particular feature, structure, or characteristic described in connection with the embodiment is included in at least one embodiment of the invention, and the appearances of these phrases in various places in the specification are not necessarily all referring to the same embodiment. Additionally, in the following detailed description, numerous specific details are set forth in order to provide a thorough understanding of the present invention. However, it will be apparent to one of ordinary skill in the art that these specific details may not all be needed to practice the present invention. In other circumstances, well-known structures, materials, circuits, processes and interfaces have not been described in detail, and/or may be illustrated in block diagram form, so as to not unnecessarily obscure the present invention.

Furthermore, some portions of the detailed description that follow are presented in terms of algorithms and symbolic representations of operations within a computer. These algorithmic descriptions and symbolic representations are the means used by those skilled in the data processing arts to most effectively convey the essence of their innovations to others skilled in the art. An algorithm is a series of defined steps leading to a desired end state or result. In the present invention, the steps carried out require physical manipulations of tangible quantities for achieving a tangible result. Usually, though not necessarily, these quantities take the form of electrical or magnetic signals or instructions capable of being stored, transferred, combined, compared, and otherwise manipulated. It has proven convenient at times, principally for reasons of common usage, to refer to these signals as bits, values, elements, symbols, characters, terms, numbers, instructions, or the like. It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “iprocessing”, “computing”, “calculating”, “determining”, “displaying”, or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

The present invention also relates to an apparatus for performing the operations herein. This apparatus may be specially constructed for the required purposes, or it may include one or more general-purpose computers selectively activated or reconfigured by one or more computer programs. Such computer programs may be stored in a computer-readable storage medium, such as, but not limited to optical disks, magnetic disks, read-only memories, random access memories, solid state devices and drives, or any other type of media suitable for storing electronic information. The algorithms and displays presented herein are not inherently related to any particular computer or other apparatus. Various general-purpose systems may be used with programs and modules in accordance with the teachings herein, or it may prove convenient to construct a more specialized apparatus to perform desired method steps. The structure for a variety of these systems will appear from the description set forth below. In addition, the present invention is not described with reference to any particular programming language. It will be appreciated that a variety of programming languages may be used to implement the teachings of the invention as described herein. The instructions of the programming language(s) may be executed by one or more processing devices, e.g., central processing units (CPUs), processors, or controllers.

Exemplary embodiments of the invention, as will be described in greater detail below, provide apparatuses, methods and computer programs for enabling a management computer to monitor the load of each array group in a storage system in order to detect any hot spots in the storage system. In exemplary embodiments of the invention, the management computer is configured to select the volume to be migrated according to a calculated shortest migration time. Because the storage controller needs to rewrite any data that is written to an already-migrated area of the volume by a host computer during the migration process, deciding to migrate the smallest volume from the hot spot is not necessarily the proper choice. Therefore, embodiments of the invention also take into account write access rates by host computers when determining which volume to migrate. In exemplary embodiments of the invention, the management computer is configured to estimate the total transfer data size and total transfer time, which enables the management computer to determine which volume will have the shortest overall total transfer time. Additionally, in some embodiments of the invention, following the migration, the storage controller may be configured to swap the logical unit numbers between source and destination volumes so that a host computer is able to access the migrated volume continually during and after the migration without disruption of service or loss of data.

Hardware Architecture, Software Modules and Data Structures

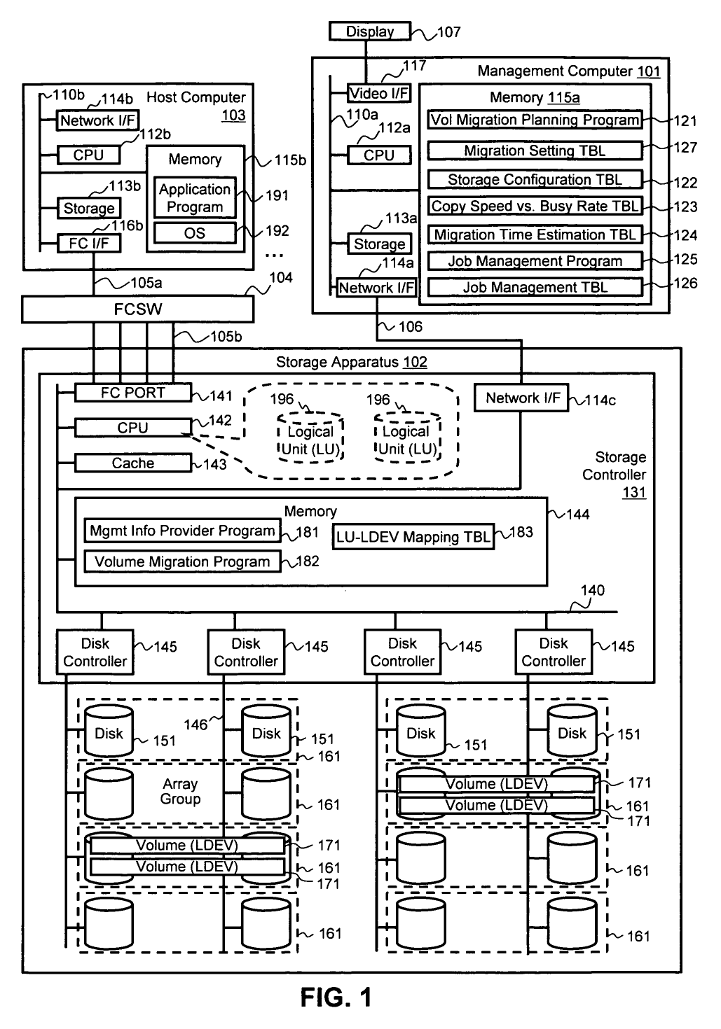

As illustrated in FIG. 1, an exemplary embodiment of an information system in which the invention may be carried out includes one or more host computers 103 in communication with a storage apparatus 102 via a Fiber Channel switch (FCSW) 104. The exemplary information system further includes a management computer 101 in communication with the storage apparatus 102 via a management network 106, which may be a LAN (local area network) or a WAN (wide area network), and which may use Ethernet( or other suitable connection equipment. Host computer 103, Fiber Channel switch 104 and storage apparatus 102 are connected through fiber cables 105a, 105b, or the like, which may be included in a SAN (storage area network) in some embodiments of the invention.

Management computer 101 may be a generic computer-that includes a CPU 112a, a memory 115a, a network interface 114a, a storage 113a, such as a HDD, and a video interface 117. These elements are connected through a system bus 110a. Network interface 114a on management computer 101 may be an Ethernet® interface (e.g., a network interface card) that is connected to the management network 106 and used to send or receive command packets to or from storage apparatus 102. A display 107 is connected to video interface 117 and used to display alerts and messages, such as may be received from a volume migration planning program 121 or a job management program 125.

Modules and programs on management computer 101 include volume migration planning program 121 and job management program 125 stored in memory 115a, storage 113a, or other computer readable mediums, and which are executed by CPU 112a. Data structures on management computer 101 that are used by volume migration planning program 121 include a migration setting table 127, a storage configuration table 122, a copy-speed-vs.-busy-rate table 123 and a migration time estimation table 124 stored in memory 115a, storage 113a, or other computer readable medium. Data structures used by job management program 125 include a job management table 126 stored in memory 115a, storage 113a, or other computer readable medium. The functions and applications of these modules and data structures are described additionally below.

Host computer 103 may also be a generic computer that includes a CPU 112b, a memory 115b, a network interface 114b, a Fiber Channel interface 116 and a storage 113b, such as a HDD, with these components being connected through system bus 110b. Software on the host computer includes an operating system (OS) 192 stored in memory 115b, storage 113b, or other computer readable medium and one or more application programs 191 running on OS 192 and stored in memory 115b, storage 113b, or other computer readable medium. Host computer 103 includes FC interface 116, such as a host bus adapter, which is connected to FC switch 104 by cable 105a and which is used to send or receive data to or from storage apparatus 102. Network interface 114b can be used to connect host computer 103 to management network 106 or other communications network.

Storage apparatus 102 comprises a storage controller 131 in operative communication with a plurality of storage mediums 151, which are HDDs in the preferred embodiments, but which may alternatively be solid state devices, optical devices or other suitable storage mediums. Storage controller 131 includes a Fiber Channel port 141, a CPU 142, a cache memory 143, a control memory 144, a network interface 114c, and plural disk controllers 145, with these components all being connected through system bus 140. Software on storage controller 131 includes a management information provider program 181 and a volume migration program 182 stored in memory 144, or other computer readable medium, and executed by CPU 142. Data structures on storage controller 131 include a logical unit to logical device (LU-LDEV) mapping table 183 stored in memory 144 or other computer readable medium, and used to map a logical unit 196 have a logical unit number (LUN) to a logical device or volume 171 created on a an array group 161. Disk controllers 145 are connected to storage mediums 151 for enabling storage controller 131 to control storage of data to the storage mediums 151 and retrieve data from storage mediums 151.

Multiple logical devices (LDEVs) 171 (also sometimes referred to as logical volumes) can be created in storage apparatus 102. Each LDEV is carved from a portion of an array group 161. Each array group 161 is composed from a plurality of the storage mediums 151 configured as a RAID (Redundant Array of Independent disks). Different array groups 161 may be composed using different types of storage mediums and different types of RAID configurations. For example, some array groups 151 may be created from FC HDDs configured in a RAID5 configuration, RAID6 configuration, or the like, while other array groups 161 may be configured from SATA HDDs configured in a RAID5 configuration, a RAID6 configuration, etc.

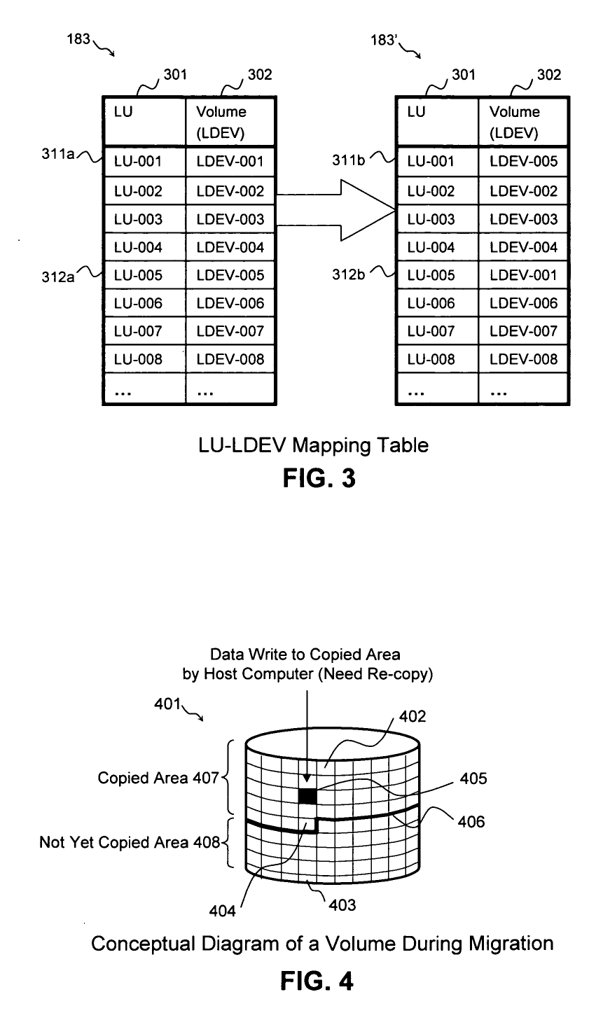

Logical unit 196 is the name of a corresponding logical device 171 when the logical device 171 is exposed to a host computer 103, and is typically provided as a LUN to the host computer 103, while logical device 171 may have a different identifier used internally within storage apparatus 102. In other words, each logical unit 196 is configured to accept access operations from a specific host computer 103, with the access being mapped to the LDEV 171. These mappings between logical units 196 and logical devices 171 are defined in LU-LDEV mapping table 183 described further below with respect to FIG. 3.

Storage Configuration Table

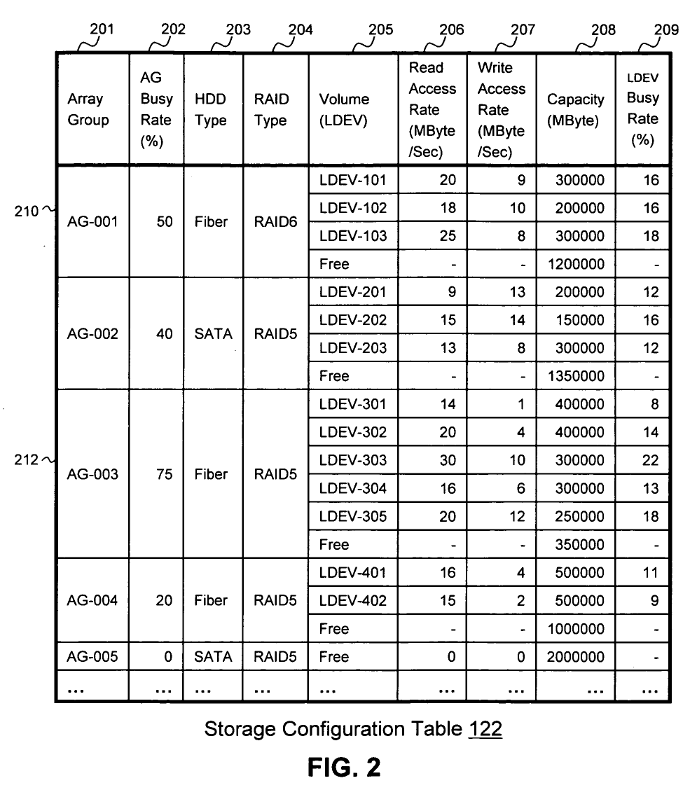

FIG. 2 illustrates an exemplary data structure of storage configuration table 122, which resides in the management computer 101. Storage configuration table 122 contains configuration information that is collected by volume migration planning program 121 running on management computer 101. Volume migration planning program 121 collects the information for storage configuration table 122 from management information provider program 181, which resides in storage controller 131. Storage configuration table 122 is used by volume migration planning program 121 in order to determine a migration plan for resolving a hot spot within storage apparatus 102. In storage configuration table 122, array group 201 identifies a particular array group which is composed from plural storage mediums 151. Array group (AG) busy rate 202 represents statistical data of the corresponding array group 201 collected by volume migration planning program 121 from management information provider program 181. AG busy rate 202 indicates how busy the particular array group is currently according to a percentage measured over a period of time, i.e., how heavy the load is on each array group. For example, line 210 indicates that array group AG-001 was busy 50 percent of the time over the most recently measured time period. Busy rate is an indication of the workload on the array group or individual storage mediums in the array group, and can be measured in terms of a total amount of access time, as measured over a total time period. Various known methods for measuring the loads on the storage mediums and/or array groups may be used for determining the busy rate, and the invention is not limited to any particular method for measuring this load. HDD type 203 indicates the type of storage medium 151 used to create the corresponding array group. RAID type 204 indicates the RAID configuration of the corresponding array group. Volume (LDEV) 205 is an internal identifier of a logical storage device that is carved from the corresponding array group 201. When the value of an entry for volume 205 is listed as “Free”, this means that the corresponding array group has free space for enabling creation of a new volume. For example, at line 210 of FIG. 2, LDEV-101, LDEV-102 and LDEV-103 are carved from array group AG-001, and AG-001 has remaining free space for enabling one or more new volumes to still be carved therefrom. Read access rate 206 indicates statistical data of the corresponding volume (LDEV) 205 collected by volume migration planning program 121 from management information provider program 181. For example, read access rate 206 is the rate of read access to data in the corresponding LDEV from host computer 103 expressed in megabytes per second (i.e., the data transfer rate for read accesses from the host computer 103). Similarly, write access rate 207 indicates statistical data of the corresponding volume (LDEV) 205 collected by volume migration planning program 121 from management information provider program 181. Write access rate 207 is the rate of write access data from host computer 103 to the LDEV expressed in megabytes per second (i.e., the data transfer rate for write accesses from host computer 103). Capacity 208 indicates the assigned capacity for storing data of the particular volume (LDEV) 205. This capacity information is collected by volume migration planning program 121 from management information provider program 181. Thus, capacity 208 is the overall capacity of the volume 205. For example, as illustrated at line 210 in FIG. 2, volume LDEV-101 has a capacity of 300,000 megabytes, and the free capacity of array group AG-001 is 1,200,000 mega bytes. LDEV busy rate 209 is statistical data of that volume (LDEV) 205 collected by volume migration planning program 121 from management information provider program 181. LDEV busy rate 209 indicates how busy that volume (LDEV) 205 is according to the most recently measured time period. For example, as indicated by line 210, LDEV-101 was busy 16 percent of the time over the last measuring period.

LU-LDEV Mapping Table

FIG. 3 illustrates an exemplary data structure of the LU-LDEV mapping table 183 that resides in the storage controller 131. LU-LDEV mapping table 183 contains mapping information of the correspondence between logical units 171 and LDEVs 196. Entry LU 301 is the logical unit identifier (typically a LUN) that is exposed to host computer 103. Entry volume (LDEV) 302 is the internal logical device identifier that identifies the corresponding volume created on an array group 161 in storage apparatus 102.

In FIG. 3, record 311a illustrates that LU-001 is mapped to LDEV-001 in LU-LDEV mapping table 183. In a similar way, record 312a illustrates that LU-005 is mapped to LDEV-005. Because the host computer 103 uses the logical unit identifier 301 to connect the volume, it is not necessary to change settings in the host computer 103 when two LDEVs are swapped, such as may occur during migration of a volume. Records 311b and record 312b in LU-LDEV mapping table 183′ illustrate the swapping of LDEV-001 with LDEV-005, for example, if the data contained in LDEV-001 is migrated to LDEV-005. When such a situation occurs, host computer 103 does not need to change its volume connection setting and can access LDEV-005 instead of LDEV-001 non-disruptively by accessing LU-001.

Volume Migration

FIG. 4 illustrates an exemplary conceptual diagram of a volume (LDEV) 401 during migration of the data contained in the volume 401 to another volume. Migration is a copy operation between two volumes carried out by volume migration program 182. Volume migration program 182 may initiate the copy operation at a data portion 402 and copy the data portions of volume 401 sequentially until the copy operation completes at data portion 403. For example, in the case where logical blocks are used, the migration operations may start at the first logical block in the volume and copy the logical blocks sequentially until the end of the volume is reached.

In the configuration illustrated in FIG. 4, the copy operation is currently on-going at data portion 404. Therefore, volume 401 can be divided into two areas, one of which is a copied area 407 (data portions that have already been copied to the destination volume) and the other of which is a not copied area 408 (data portions which have not yet been copied to the destination volume). The boundary between these two areas is illustrated as boundary line 406. However, during the migration process, when host computer 103 makes a write access to copied area 407, such as to data portion 405, volume migration program 182 will need to re-copy that data portion 405 to the destination volume. Accordingly, it may be seen that if there are a large number of write accesses to copied area 407 during the migration process then the migration process may be greatly extended.

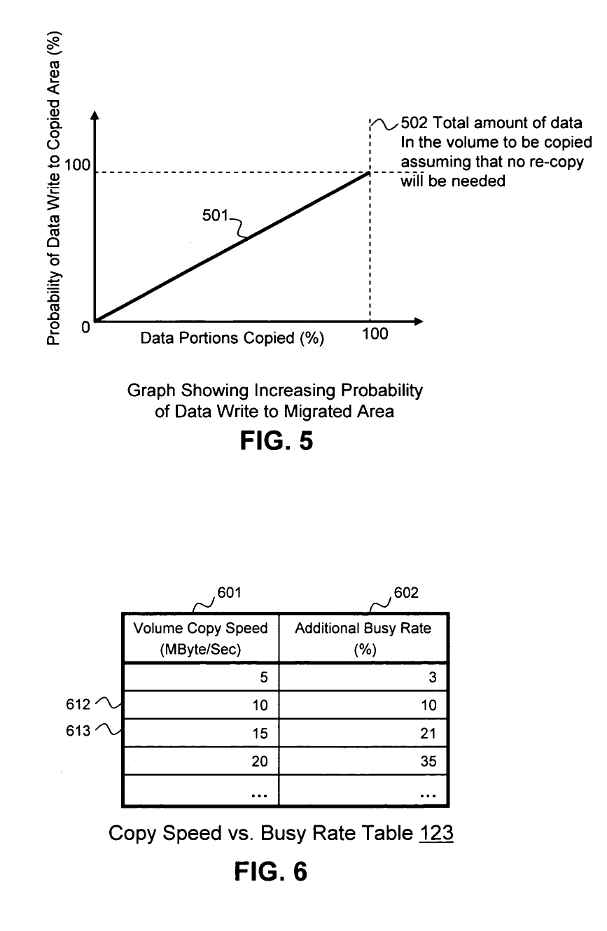

FIG. 5 illustrates an exemplary graph demonstrating the probability of data writes to copied area 407 as it corresponds to the increasing size of copied area 407. In FIG. 5, line 501 illustrates that the probability of a data write to the copied area 407 increases in accordance with an increase the size of the copied area. For example, assuming that data writes from host computer 103 are distributed evenly over the entire volume 401, then, as the copied area increases, probability of a data write to an already migrated area also increases. For example, as the number of data portions copied approaches 100%, as indicated by line 502, then the probability of a data write to an already migrated data portion also approaches 100%.

Copy Speed vs. Busy Rate Table

FIG. 6 illustrates an exemplary data structure of the copy speed vs. busy rate table 123 that resides in the management computer 101. Copy speed vs. busy rate table 123 contains an additional busy rate entry 602 that corresponding to a volume copy speed entry 601. Volume migration planning program 121 refers to copy speed vs. busy rate table 123 to determine an appropriate copy speed for migration so that the total busy rate of array groups involved in the migration process will not exceed a threshold set in migration setting table 127 (discussed further with reference to FIG. 14).

Migration Time Estimation Table

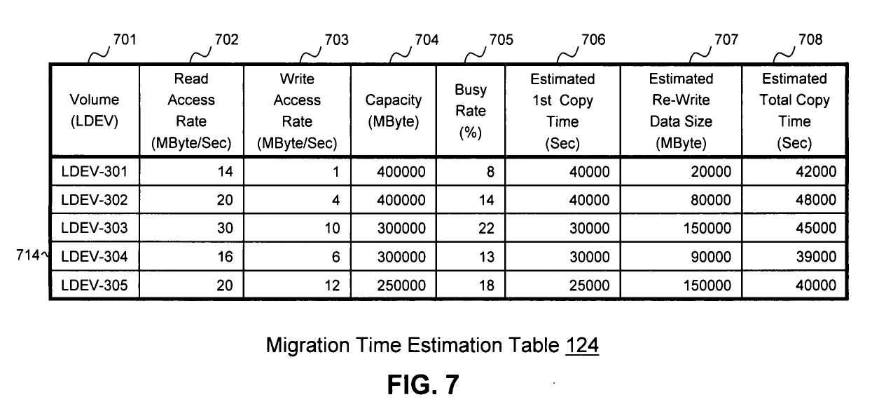

FIG. 7 illustrates an exemplary data structure of the migration time estimation table 124 that resides in the management computer 101. Migration time estimation table 124 contains statistical information for each volume (LDEV) in a candidate array group that is a candidate to be a destination of volume migration for reducing a hot spot. Migration time estimation table 124 is used by volume migration planning program 121 to calculate the estimated total copy time so that volume migration planning program 121 is able to determine a more accurate data migration plan. In migration time estimation table 124, volume (LDEV) 701 is the internal volume identifier. These volume identifiers are copied from the column of volume (LDEV) 205 on storage configuration table 122. The values of read access rate 702, write access rate 703, capacity 704 and busy rate 705 are also copied respectively from the columns 206 to 209 on storage configuration table 122. For instance, FIG. 7 represents an example in which a hot spot in the storage system 102 exists at array group “AG-003”, which, as also illustrated at line 212 in storage configuration table 122 of FIG. 2 currently has an array group busy rate of 75% and has five LDEVs having identifiers LDEV-301, LDEV-302, LDEV-303, LDEV-304 and LDEV-305. So volume migration planning program 121 copies the information of these LDEVs from column 205, 206, 207, 208 and 209 to the corresponding columns 701, 702, 703, 704 and 705 of migration time estimation table 124 respectively.

Estimated first copy time 706 is the time calculated by volume migration planning program 121 for copying of the data currently in the LDEV. The value for Estimated 1st copy time 706 is calculated using the following formula:

Capacity (MByte) 704/volume copy speed (MByte/Sec) 601

Estimated 1st copy time 706 is the time value that will be required to copy data to a destination LDEV when no write accesses from host computer 103 occur.

Estimated re-write data size 707 is the size of the data that is estimated that will have to be copied again to the destination volume following write accesses from host computer 103. Estimated re-write data size 707 can be calculated by using a following formula:

((Estimated 1st copy time)*Write Access Rate)/2

Thus, after copying the contents of the source volume to the destination volume, this is the estimated amount of data that will need to be copied again because these data portions were changed by being written to by host computer 103 during the original copying of the data for migration.

The total size of data to be copied from the source volume to the destination volume can be calculated as follows:

Capacity 704+Estimated re-write data size 707

From the total data size to be copied, the estimated total copy time 708 that will be required to carry out the migration can be calculated. Estimated total copy time 708 can be calculated according to the following formula:

Total copying data size*volume copy rate 601

Volume copy rate 601 is determined empirically by volume migration planning program 121.

Job Management Table

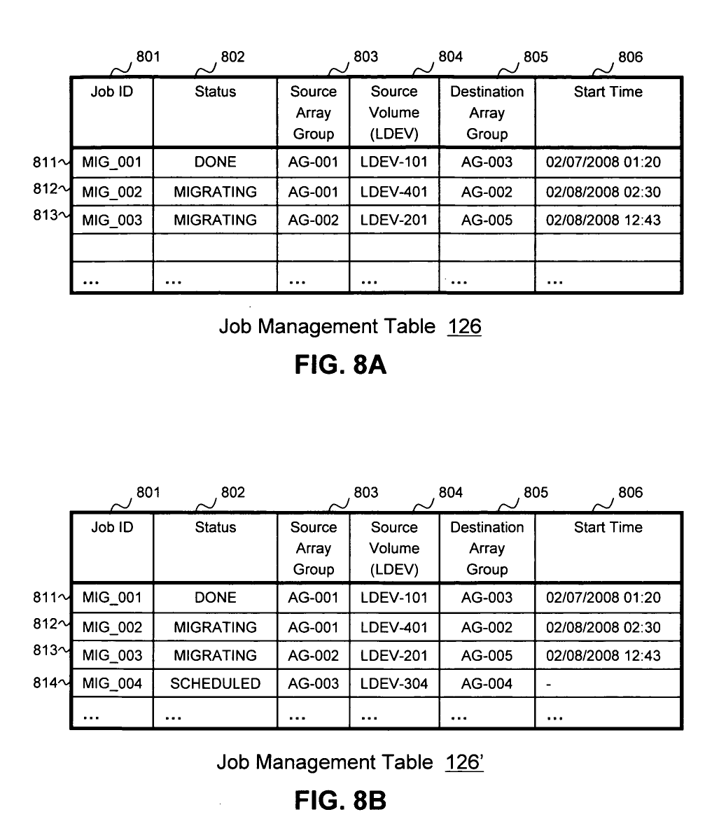

FIG. 8A illustrates an exemplary data structure of the job management table 126 that resides in the management computer 101. Job management table 126 is created by volume migration planning program 121 for managing the migration jobs. Job management table 126 is referred to by job management program 125 during its processing. Job management table 126 includes a job ID 801 which is the job identifier assigned by the volume migration planning program for identifying the particular migration job. Status 802 represents the status of the migration job. The value of Status 802 can be one of three statuses, namely, “DONE”, “MIGRATING” or “SCHEDULED”. “DONE” indicates that the migration job has been completed successfully. “MIGRATING” indicates that the migration job is currently being carried out. “SCHEDULED” indicates that the migration job has been scheduled and is currently waiting to be executed. Status 802 is changed by job management program 125 according to job execution progress. Source array group 803 indicates the source array group of the corresponding migration job. Source volume 804 indicates the source volume of the corresponding migration job. Destination array group indicates the destination array group of the corresponding migration job. Start time 806 indicates the date and time when the migration job started. Accordingly, in the illustrated example, as indicated at entry 811, job ID “MIG_{—}001” which entailed migration of LDEV-101 from array group AG-001 to array group AG-003 has been completed, while job IDs MIG_{—}002 and MIG_{—}003 are still ongoing, as indicated at entries 812 and 813, respectively. FIG. 8B illustrates the job management table 126′, following addition of another job entry at line 814 as discussed further in the example below.

Migration Setting Table

FIG. 14 illustrates the migration setting table 126 that resides in the management computer 101. Migration setting table 126 contains the values of thresholds of parameters used for carrying out migration. Name 1401 is the name of the particular parameter, and value 1402 is the value of parameter. In FIG. 14, two parameters (thresholds) are defined. A first parameter is the “Threshold-for-Detecting-Hot-Spot” 1411 and the other parameter is “Max-Busy-Rate-for-Migration” 1412. Threshold-for-Detecting-Hot-Spot 1411 is used for detecting hot spots in the storage system, and refers to the array group busy rate 202 illustrated in storage configuration table 122 of FIG. 2. Migration setting table 126 indicates that the threshold value for this parameter is currently 70%, and thus when the array group busy rate 202 exceeds 70% a hot spot is determined to exist. Max-Busy-Rate-for-Migration 1412 is used for determining the volume copy speed of migration used when copying data from a source array group to a destination array group.

Exemplary Process of Volume Migration Scheduling System

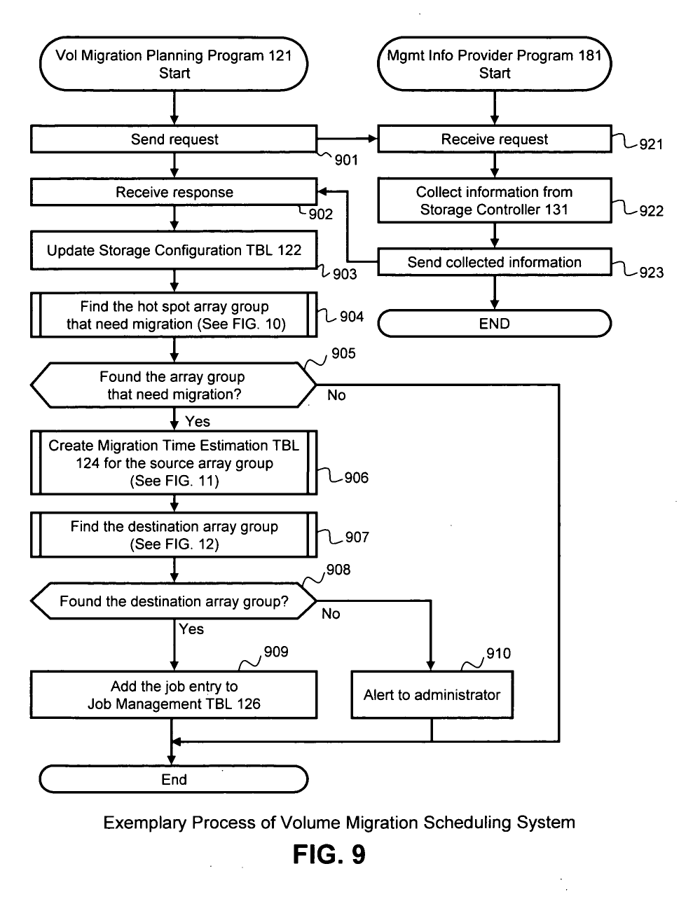

FIG. 9 illustrates a flowchart of representative of an exemplary process for a volume migration scheduling system used in the invention. In the process illustrated in FIG. 9, there are two programs, one of which is volume migration planning program 121, which resides in management computer 101, and the other of which is management information provider program 181, which resides in storage controller 131. Volume migration planning program 121 initiates the process periodically following a predetermined interval.

In step 901, volume migration planning program 121 sends a request to management information provider program 181 for collection and retrieval of configuration information and statistical information regarding the storage system 102.

In step 921, management information provider program 181 receives the request sent from volume migration planning program 121.

In step 922, management information provider program 181 collects information from storage controller 131 regarding current configuration and performance of storage system 102.

In step 923, management information provider program 181 sends the collected information back to volume migration planning program 121.

In step 902, volume migration planning program 121 receives the information regarding the storage system 102 from management information provider program 181.

In step 903, volume migration planning program 121 creates or updates storage configuration table 122 with received information.

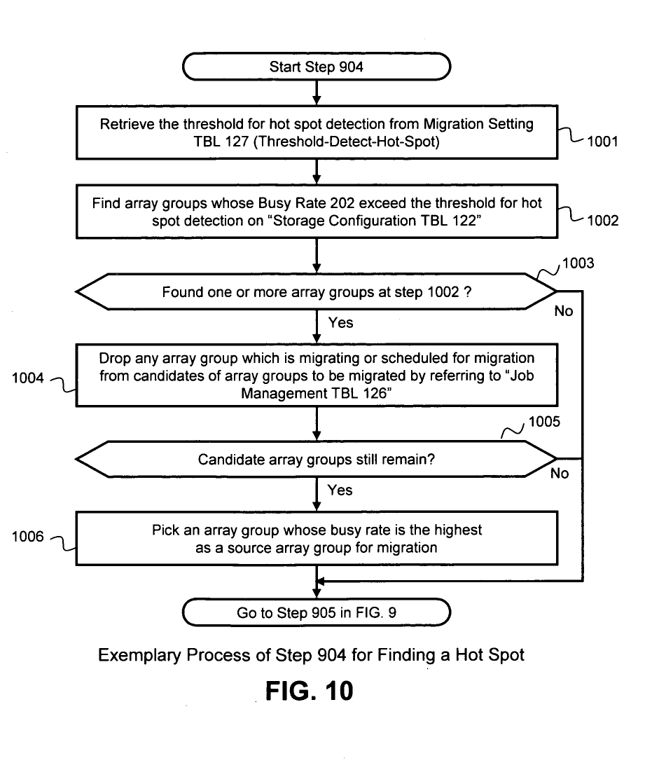

In step 904, volume migration planning program 121 finds the hot spot array group that needs to be dissolved by migration. A flowchart of an exemplary process for locating a hot spot in storage system 102 is illustrated in FIG. 10.

In step 905, if the result of step 904 indicates that a hot spot array group was found, then the process goes to step 906. However if a hot spot is not found, volume migration planning program 121 ends the process.

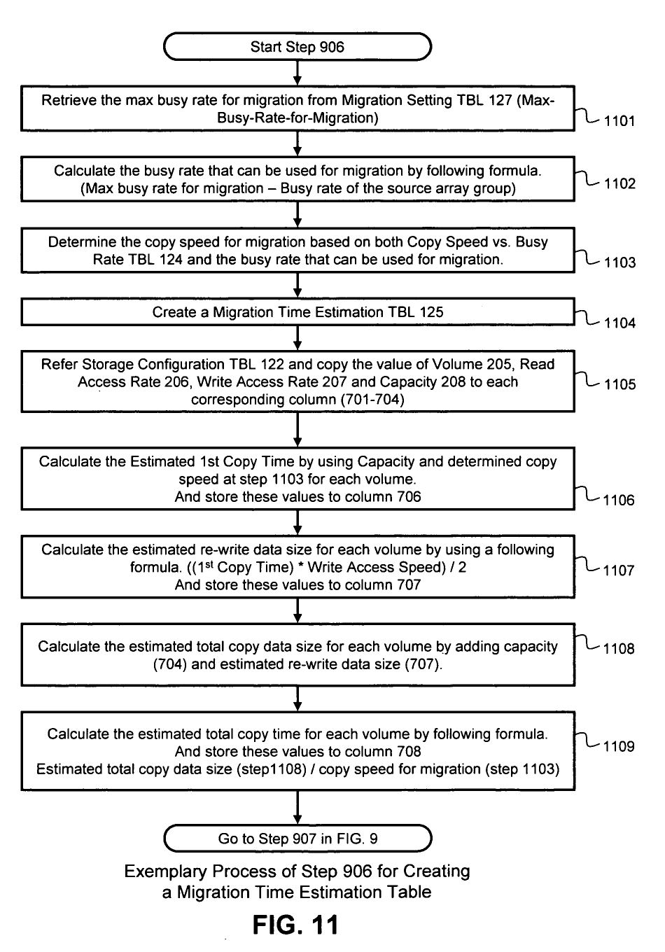

In step 906, volume migration planning program 121 creates migration time estimation table 124 for the hot spot array group located in step 904. FIG. 11 illustrates a flowchart of an exemplary process carried out in this step for creating the migration time estimation table 124.

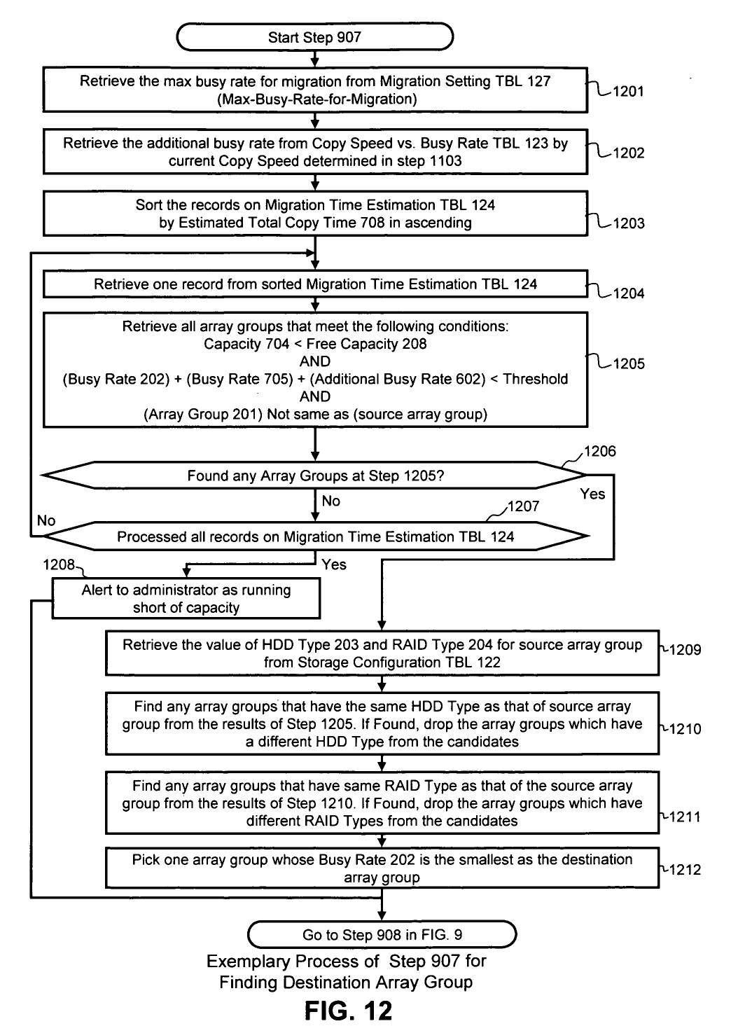

In step 907, volume migration planning program 121 locates an appropriate destination array group. FIG. 12 illustrates a flowchart of an exemplary process carried out in this step for locating an appropriate destination array group.

In step 908, when the result of step 907 indicates that a suitable destination array group was found, the process goes to step 909. On the other hand, when a suitable destination array group was not found, the process goes to 910 to alert the administrator.

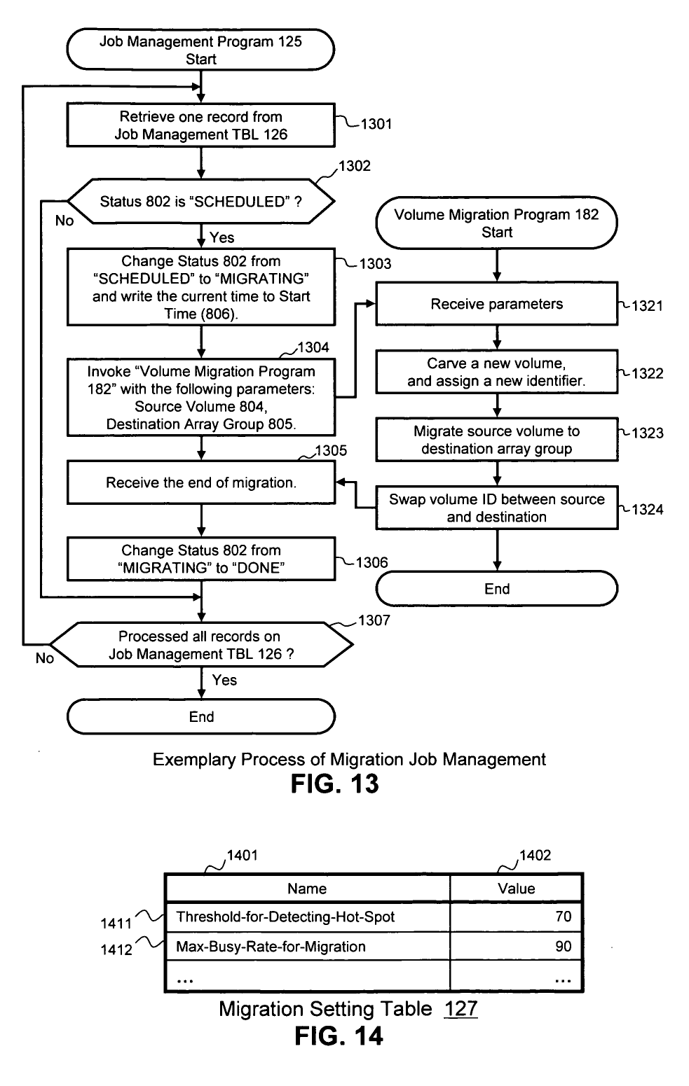

In step 909, volume migration planning program 121 adds the job entry to job management table 126. A typical Job entry consists of Job ID 801, Status 802, Source array group 803, Source volume 804, and Destination array group 805. Status 802 must be set as “SCHEDULED” at this time. The added job entry will be executed by job management program 125, as discussed below with reference to FIG. 13, independently of the processing of volume migration planning program 121.

In step 910, volume migration planning program 121 sends an alert to the administrator of the system indicating that process was unable to locate a suitable destination array group. For example, when the capacity of the storage system 102 is highly utilize, there may arise situations in which it is not possible to locate a suitable destination array group.

Exemplary Process for Locating Hot Spots

FIG. 10 illustrates a flowchart of an exemplary process carried out for step 904 of FIG. 9 for finding a hot spot in storage system 102 that needs to be dissolved by data migration.

In step 1001, volume migration planning program 121 retrieves the threshold for hot spot detection 1411 from migration setting table 127 in FIG. 14. In the example illustrated in FIG. 14, the threshold for detecting hot spot 1411 is a 70 percent array group busy rate.

In step 1002, volume migration planning program 121 determines whether there are any array groups whose busy rate 202 on storage configuration table 122 exceeds the threshold for hot spot detection 1411. According to the example illustrated in FIG. 2, as indicated at entry 212, the busy rate of array group AG-003 is 75%, which exceeds the threshold of 70%.

In step 1003, if one or more array groups is found in step 1002 that meet the threshold for a hot spot, then the process goes to step 1004. On the other hand, when no hot spots are detected, the volume migration planning program 121 ends processing via step 905 in FIG. 9.

In step 1004, volume migration planning program 121 determines whether any of the array groups located in step 1002 are already listed in job management table 126 as undergoing migration or listed as being scheduled for migration. When an array group located in step 1002 is already listed on job management table 126 as being migrated or scheduled for migration, volume migration planning program 121 drops that array group from the candidates of array groups to be migrated. According to the example of job management table 126 illustrated in FIG. 8A, array group AG-003 is neither in the process of migration nor already scheduled for migration. On the other hand, if either of array groups AG-001 or AG-002 was found in step 1002, then these array groups are dropped in step 1004, as they are currently already undergoing migration.

In step 1005, volume migration planning program 121 checks whether any candidate array groups still remain as candidates for migration. If one or more candidate array groups remain, the process goes to step 1006. On the other hand, if there are no candidate array groups remaining, volume migration planning program 121 ends processing via step 905 in FIG. 9.

In step 1006, out of the candidate array groups, volume migration planning program 121 picks an array group whose array group busy rate is the highest as a source array group for migration. In the example set forth in storage configuration table 122 of FIG. 2, array group AG-003 is selected as the source array group for migration by step 904, and the process returns to step 905 in FIG. 9.

Exemplary Process of Creating Migration Time Estimation Table

FIG. 11 illustrates a flowchart of and exemplary process carried out in step 906 of FIG. 9 for creating migration time estimation table 124 in preparation for selecting a source volume to be migrated from among the volumes contained in the array group identified as the candidate for migration in step 904 (FIG. 10).

In step 1101, volume migration planning program 121 retrieves the max busy rate for migration 1412 from migration setting table 127 According to the example illustrated in FIG. 14, this max busy rate has a value of 90%.

In step 1102, volume migration planning program 121 calculates the busy rate that can be used for migration according to the following formula:

Max busy rate for migration−Busy rate of the source array group

Since the max busy rate for migration is 90%, and the array group busy rate of the source array group is 75%, then by applying the above formula,

90%−75%=15%

which indicates that 15% of the array group's time can be used for migration. The max busy rate is generally set by the administrator, and may differ from system to system, depending on the application and desired performance of a particular system.

In step 1103, volume migration planning program 121 determines the copy speed for migration based on both copy speed vs. busy rate table 123 and the busy rate that can be used for migration (result of step 1102. In particular, volume migration planning program 121 refers to the corresponding entry for additional busy rate 602 on copy speed vs. busy rate table 123 from FIG. 6 and finds the largest value that does not exceed the busy rate that can be used for migration (result of step 1102). For instance, in the example illustrated in FIG. 6, line 613 indicates that additional busy rate 602 at line 613 is 21. But the value “21%” exceeds the 15% calculated in step 1102 above. However, the additional busy rate 602 on the record 612 is 10%, which does not exceed the 15% calculated in step 1102 above. The corresponding value of volume copy Speed 601 on the record 612 is 10 (MByte/Sec). So volume migration planning program 121 determines that volume copy speed to be used for the migration is 10 (MByte/Sec).

In step 1104, volume migration planning program 121 initiates creation of a migration time estimation table 124.

In step 1105, volume migration planning program 121 refers to storage configuration table 122 and copies the values of volume 205, read access rate 206, write access rate 207, capacity 208 and busy rate 209 of the source array group to each corresponding column 701-705 of migration time estimation table 124. For example, the source array group is now AG-003. So, volume migration planning program 121 copies the values for LDEV-301, LDEV-302, LDEV-303, LDEV-304 and LDEV-305 to migration time estimation table 124. Thus, the number of records on migration time estimation table 124 in this example is five, as illustrated in FIG. 7.

In step 1106, volume migration planning program 121 calculates the estimated 1st copy time 706 by using capacity 704 and the copy speed determined at step 1103 for each LDEV, and stores these values to column 706 of migration time estimation table 124. For example, because the volume copy speed was determined to be 10 (MByte/Sec) (result of step 1103) and because the value of capacity 704 on the record of 711 is 400000 (MByte), then the estimated first copy time 706 is determined by

400000/10=40000 (Sec).

In step 1107, volume migration planning program 121 calculates the estimated re-write data size for each volume by using a following formula:

(Estimated 1st copy time*Write Access Speed)/2

and stores the calculated values as estimated rewrite data size 707 in migration time estimation table 124. This formula is derived from FIG. 4 and FIG. 5. In particular, Estimated 1st copy time*Write Access Speed is the estimated data size written by host computer 103 during the migration. But all of that data does not need to re-written because host computer 103 may write data to the same portion of a copied area while volume migration program 182 is copying other areas (not-yet copied areas). In other words, about half of that data is written into not copied area 408, so only about half of that data will need to be re-written.

In step 1108, volume migration planning program 121 calculates the estimated total copy data size for each volume by adding capacity 704 and estimated re-write data size 707.

In step 1109, volume migration planning program 121 calculates the estimated total copy time for each volume by following formula:

Estimated total copy data size (step 1108)/copy speed for migration (step 1103)

and stores the calculated values as estimated rewrite data size 707 in migration time estimation table 124. Following completion of the migration time estimation table 124, the process returns to step 907 of FIG. 9.

Exemplary Process for Finding a Destination Array Group

FIG. 12 illustrates a flowchart of and exemplary process carried out in step 906 of FIG. 9 for selecting a destination array group to be the target of migration from the source array identified in step 904 of FIG. 9.

In step 1201, volume migration planning program 121 retrieves the max busy rate for migration from migration setting table 127 (Max-Busy-Rate-for-Migration 1412). In the example illustrated in FIG. 14, this value is 90%.

In step 1202, volume migration planning program 121 retrieves the additional busy rate from copy speed vs. busy rate table 123 by using the current copy speed determined in step 1103 of FIG. 11. In the example discussed in FIG. 11 at step 1103, the current copy speed was determined as 10 (MByte/Sec), so the additional busy rate would be 10%.

In step 1203, volume migration planning program 121 sorts the records on migration time estimation table 124 by estimated total copy time 708 in ascending order. For example, record 714 in migration time estimation table 124 would be the first record, since it has the shortest estimated total copy time 708 of 39000 seconds.

In step 1204, volume migration planning program 121 retrieves one record for an LDEV from the sorted migration time estimation table 124 for processing in the following steps 1205-1207. For example, the first record 714 having the shortest estimated total copy time 708 can be selected first for processing, although other selection techniques might also be applied.

In step 1205, volume migration planning program 121 retrieves all records of array groups that meet following conditions:

capacity 704 of selected LDEV<Free capacity 208

AND

(busy rate 202)+(busy rate 705 of selected LDEV)+(Additional busy rate (determined in step 1202))<Threshold (determined in step 1201)

AND

(array group 201) is not the same as (source array group (step 904)).

For example, if record 714 in migration time estimation table 124 is being processed, then capacity 704 is 300000 (MByte), so AG-001, AG-002, AG-003, AG-004 and AG-005 all meet the first part of the condition of having capacity greater than the capacity of the selected LDEV. The busy rate 705 of record 714 is 13%, the additional busy rate is 10% (determined in step 1202), and the threshold is 90% (determined in step 1201). Thus, any array group whose busy rate is under 67(%) can be destination array group, and array groups AG-001, AG-002, AG-004 and AG-005 meet the second part of the condition. The source array group is now AG-003. So if AG-003 is included among the candidates, AG-003 will be dropped. But AG-003 is not currently a candidate, so array groups AG-001, AG-002, AG-004 and AG-005 meet the conditions of step 1205.

In step 1206, volume migration planning program 121 checks whether any candidate array groups remain as possible destination array groups. If yes, the process goes to step 1209 for further processing of the remaining candidate array groups. If not, the process goes to step 1207. For example, currently volume migration planning program 121 has AG-001, AG-002, AG-004 and AG-005 as candidates of the destination array group, so the process goes to step 1209.

In step 1207, if no candidate array groups remain in step 1206, the process checks whether all records on migration time estimation table 124 have been processed or not. If not, the process goes back to step 1204 to select the next record from the sorted migration time estimation table 124, and again performs steps 1205 and 1206. On the other hand, if all records in sorted migration time estimation table 124 have been processed, the process goes to step 1208.

In step 1208, volume migration planning program 121 notifies an alert to the administrator, such as via display 107 of management computer 101, to indicate that there not a sufficient of free capacity to perform migration of any volumes from the hot spot array group in the storage apparatus 102.

In step 1209, volume migration planning program 121 refers to storage configuration table 122 of FIG. 2, and retrieves the value of HDD Type 203 and RAID Type 204 of the source array group from storage configuration table 122. According to the example in FIG. 2, the HDD Type 203 is “Fiber” and the RAID Type 204 is “RAID5”.

In step 1210, volume migration planning program 121 locates any array groups that have the same HDD Type as that of source AG from the result of Step 1205. If an array group is found having the same HDD type, the array groups which have different HDD types are eliminated from the candidate pool. In the example illustrated in FIG. 2, because the HDD Type of array groups AG-001 and AG-004 is “Fiber”, array groups AG-002 and AG-005 would be dropped from the pool of candidates.

In step 1211, volume migration planning program 121 determines whether any of the remaining array groups have the same RAID Type 204 as that of the source array group following the results of step 1210. If an array group is found that has the same RAID type, the process eliminates the candidate array group which have a different RAID type from the pool of candidate. In the example illustrated in FIG. 2, because the RAID type of AG-003 is RAID5 and the RAID type of AG-004 is also RAID5, while that of AG-001 is RAID6, array group AG-001 would be dropped from the pool of candidates.

In step 1212, volume migration planning program 121 picks one array group remaining from the pool of candidates whose busy rate 202 is the smallest as the destination array group. In this case, as of step 1211, only AG-004 is a remaining candidate, so the destination array group would be AG-004. Further, because a candidate destination was successfully located, the LDEV to be migrated was also established. In this example, LDEV-304 corresponding to record 714 in migration time estimation table 124 is established as the source volume 804 for migration which will be entered in job management table 126′ in step 909.

Additionally, it should be noted that migration across the different types of HDDs and RAID types is possible. But the service level (e.g., performance, data protection, etc.) after the migration cannot be guaranteed. So the migration across the same types of HDD and RAID type is typically recommended. However, the formation of a hot spot in a storage system is considered an emergency in some situations, so the invention allows for automatic migration across the different types of HDDs and RAID types.

Volume Migration Scheduling System

FIG. 13 illustrates a flowchart of and exemplary process for migration job management and execution processing. In the illustrated embodiment of FIG. 13, there are two programs that interact, one of which is job management program 125, which resides in management computer 101 and the other of which is volume migration program 182, which resides in storage controller 131.

In step 1301, job management program 125 retrieves one record from job management table 126. For example, job management program may periodically check the job management table 126 for locating new migration jobs that are scheduled to be executed.

In step 1302, job management program 125 checks whether the Status 802 of the select the record is “SCHEDULED” or not. When the status of the selected record is “SCHEDULED”, the process goes to step 1303. On the other hand, when the status of the select the record is not “SCHEDULED”, the process goes to step 1307.

In step 1303, job management program 125 changes the value of Status 802 for the selected record from “SCHEDULED” to “MIGRATING”, and also writes the current time to Start Time 806.

In step 1304, job management program 125 invokes volume migration program 182 with the parameters of Source volume 804 and Destination array group 805. According to the example illustrated in FIG. 8B for record 814, the parameters are Source volume 804=“LDEV-304” and Destination array group 805=“AG-004”.

In step 1321, volume migration program 182 receives the parameters.

In step 1322, volume migration program 182 carves a new volume from the destination array group, and assigns a new identifier. For instance, in the example illustrated in FIG. 2, a new LDEV will be created having a capacity at least equal to the capacity of LDEV-304, and will be assigned a new identifier such as, for example, LDEV-403, and may also be assigned a new LU number 301, for listing in LU-LDEV mapping table 183.

In step 1323, volume migration program 182 starts to migrate the source volume to the destination volume carved in step 1322.

In step 1324, volume migration program 182 swaps the LU number identifiers 301 between the source LDEV and the destination LDEV. Accordingly a host computer 103 is still able to use the same LU number that was previously used to access the LDEV-304 for now accessing the new LDEV-403.

In step 1305, job management program 125 receive notification of the completion of migration.

In step 1306, job management program 125 changes the value of the value of Status 802 from “MIGRATING” to “DONE” in job management table 126.

In step 1307, job management program 125 checks whether all records on job management table 126 have been processed or not. If yes, job management program 125 ends the process. If not, job management program 125 goes to step 1301 for retrieving the next record for processing from job management table 126.

From the foregoing, it will be apparent that embodiments of the invention provide for dissolving of hot spots in a storage system in the shortest possible time. Embodiments of the invention can be implemented in storage management software or in a storage management micro program in the storage sub system (e.g., storage apparatus 102). Embodiments of the invention offer a solution to enable selection of a particular volume to be migrated with a minimum workload, and to also choose the most appropriate destination. In embodiments of the invention, the management computer may monitor the load of each array group in a storage system in order to detect hot spots, and the management computer is able to calculate estimated migration times for selecting a volume to be migrated from a hot spot according to shortest estimated time. Furthermore, because the storage controller needs to rewrite the data that is written to an already-migrated area by a host computer during the migration, choosing the smallest volume is not necessarily the only consideration that should be taken into account. Therefore, embodiments of the invention also provides for considering the write access rates by host computers when determining a candidate for migration. Thus according to exemplary embodiments of the invention, the management computer is configured to estimate the total transfer data size and total transfer time, so that management computer can select the volume that will have the shortest total transfer time. Furthermore, according to embodiments of the invention, after the migration to the new LDEV is complete, the storage controller can be configured to swap the logical unit numbers between the source LDEV and the destination LDEV so that the host computer is able to continue to access the migrated volume continually and without disruption.

Of course, the system configuration illustrated in FIG. 1 is purely exemplary of an information system in which the present invention may be implemented, and the invention is not limited to a particular hardware configuration. For example, the storage controller may be a separate device from one or more array devices in which the storage mediums 151 are contained, and the controller may be connected to the array devices over a network connection, such as a backend SAN, or the like. In such an arrangement, storage controller 131 may be configured to present virtual volumes to host computer 103, with the virtual volumes mapping to the LDEVs 171 on the array devices. Further, the migration from one array group to another array group may take place over a network connection between array devices, or the like. Also, in some embodiments, the modules and data structures 121-127 implemented in management computer 101 for carrying out the processes of the invention may alternatively be located in memory 144 of storage controller 131 and be executed by CPU 142 in storage controller 131 instead of being executed by management computer 101. In addition, the invention may be applied to hot spots on individual storage mediums instead of array groups.

Additionally, the computers and storage systems implementing the invention can also have known I/O devices (e.g., CD and DVD drives, floppy disk drives, hard drives, etc.) which can store and read the modules, programs and data structures used to implement the above-described invention. These modules, programs and data structures can be encoded on such computer-readable media. For example, the data structures of the invention can be stored on computer-readable media independently of one or more computer-readable media on which reside the programs used in the invention. The components of the system can be interconnected by any form or medium of digital data communication, e.g., a communication network. Examples of communication networks include local area networks, wide area networks, e.g., the Internet, wireless networks, storage area networks, and the like.

In the description, numerous details are set forth for purposes of explanation in order to provide a thorough understanding of the present invention. However, it will be apparent to one skilled in the art that not all of these specific details are required in order to practice the present invention. It is also noted that the invention may be described as a process, which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged.

As is known in the art, the operations described above can be performed by hardware, software, or some combination of software and hardware. Various aspects of embodiments of the invention may be implemented using circuits and logic devices (hardware), while other aspects may be implemented using instructions stored on a machine-readable medium (software), which if executed by a processor, would cause the processor to perform a method to carry out embodiments of the invention. Furthermore, some embodiments of the invention may be performed solely in hardware, whereas other embodiments may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

From the foregoing, it will be apparent that the invention provides methods, apparatuses and programs stored on computer readable media for dissolving hot spots in storage systems by data migration so that the migration time is minimized. Additionally, while specific embodiments have been illustrated and described in this specification, those of ordinary skill in the art appreciate that any arrangement that is calculated to achieve the same purpose may be substituted for the specific embodiments disclosed. This disclosure is intended to cover any and all adaptations or variations of the present invention, and it is to be understood that the terms used in the following claims should not be construed to limit the invention to the specific embodiments disclosed in the specification. Rather, the scope of the invention is to be determined entirely by the following claims, which are to be construed in accordance with the established doctrines of claim interpretation, along with the full range of equivalents to which such claims are entitled.

What is claimed is:

1. An information system comprising:
a processor in communication with a plurality of storage mediums; and
a plurality of array groups formed on the storage mediums, wherein said processor is configured to identify a first array group of said plurality of array groups whose load exceeds a predetermined threshold, said first array group having a plurality of logical volumes created thereon,
wherein said processor is configured to calculate an estimated time for migrating each of said plurality of volumes from said first array group to another array group, and
wherein said processor is configured to instruct migration of a first volume of said plurality of volumes to the other array group, said first volume having a shortest estimated time for migration from among said plurality of volumes.

2. The information system according to claim 1,
wherein said estimated time to migrate a particular volume includes a first time estimated for copying data contained in the particular volume to another volume plus a second time estimated for copying re-write data comprised of data portions of the particular volume which are updated during the migration.

3. The information system according to claim 2,
wherein the second time estimated for copying the re-write data is based upon a statistical probability of a predicted number of updates to data portions of the particular volume which will have already been migrated.

4. The information system according to claim 2,
wherein said estimated time to migrate the particular volume further includes calculating an estimated busy rate for the first array group and basing the estimated time to migrate at least in part upon maintaining the busy rate for the first array group below a maximum allowable busy rate threshold.

5. The information system according to claim 1,
wherein said other array group is one of a plurality of second array groups different from said first array group, and
wherein said processor is configured to select said other array group from among said plurality of second array groups based at least in part upon current loads on said second array groups.

6. The information system according to claim 5,
wherein, when there are multiple second array groups available for receiving the migration, said process is configured to select as said other array group one of said second array groups having a same storage medium type and/or RAID configuration type as said first array group.

7. The information system according to claim 1, further comprising:
a storage controller in communication with said storage mediums for controlling access to said storage mediums; and
a management computer in communication with said storage controller via a network, wherein said processor is located in said management computer.

8. The information system according to claim 7,
wherein said management computer is configured to obtain from said storage controller information regarding the loads on each of said plurality of array groups for use in determining whether the loads on any of said array groups exceed said predetermined threshold.

9. The information system according to claim 1,
wherein the data stored in said first volume is copied to a second volume in the other array group during the migration, and
wherein, following completion of the migration, a logical identifier used by a host computer to access the first volume is reassigned to the second volume to enable the host computer to continue to access the data following migration of the data to the second volume.

10. The information system according to claim 1,
wherein said processor is configured to identify the first array group of said array groups whose load exceeds the predetermined threshold by obtaining a measurement of a load on each array group formed from said storage mediums, and determining from the obtained load measurement for each array group whether any of said array groups exceeds said predetermined threshold.

11. A method of operating an information system, comprising:
creating a plurality of array groups on a plurality of storage mediums configured for storing data;
identifying a first array group of said plurality of array groups whose load exceeds a predetermined threshold, said first array group having a plurality of logical volumes created there on;
calculating an estimated time for migrating each of said plurality of volumes from said first array group to another array group of said plurality of array groups; and
instructing migration of a first volume of said plurality of volumes to the other array group, said first volume being selected based at least in part upon said estimated times for migrating calculated for each of said plurality of volumes.

12. The method according to claim 11,
wherein the step of calculating said estimated time for migrating a particular volume further includes:
calculating a first time estimated for copying data of the particular volume to another volume in the other array group; and
adding the first time to a second time estimated for copying re-write data comprised of data portions of the particular volume which have been updated during the migration.

13. The method according to claim 12,
wherein the step of calculating said estimated time for migrating a particular volume further includes:
calculating an estimated busy rate for the first array group and basing the estimated time for migrating at least in part upon maintaining the busy rate for the first array group below a maximum allowable busy rate threshold.

14. The method according to claim 11,
wherein said other array group is one of a plurality of second array groups different from said first array group, and further including a step of selecting said other array group from among said plurality of second array groups based at least in part upon current loads on said second array groups and available capacity of said second array groups.

15. The method according to claim 11, further including a step of
selecting as said other array group one of said second array groups having a same storage medium type and/or RAID configuration type as said first array group when there are multiple second array groups available for receiving the migration.

16. The method according to claim 11, further including steps of
providing a storage controller in communication with said storage mediums for controlling access to said storage mediums;
providing a management computer in communication with said storage controller via a network; and
obtaining, by said management computer from said storage controller, information regarding the loads on each of said plurality of array groups for use in determining whether the loads on any of said array groups exceed said predetermined threshold.

17. The method according to claim 11, further including steps of
copying data stored in said first volume to a second volume in the other array group in response to the instruction for migrating; and
reassigning a logical identifier used by a host computer to access the first volume to the second volume to enable the host computer to continue to access the data following migration of the data to the second volume.

18. A method of operating an information system, comprising:
providing a management computer in communication with a storage system, said storage system having a storage controller for controlling access to a plurality of storage mediums;
creating a plurality of array groups on the plurality of storage mediums;
requesting, by said management computer, load information from said storage controller regarding loads on the array groups;
identifying a first array group of said plurality of array groups whose load exceeds a predetermined threshold, said first array group having a plurality of logical volumes created thereon and being accessed by I/O operations; and
calculating an estimated time for migrating each of said plurality of volumes from said first array group, said estimated time for migrating each particular volume being based upon a first estimated time for copying data contained in the particular volume plus a second estimated time for copying be write data comprised of data portions of the particular volume which have been updated during the migration.

19. The method according to claim 18, further including a step of
instructing migration of a first volume of said plurality of volumes to the other array group, said first volume being selected based at least in part upon said estimated times for migrating calculated for each of said plurality of volumes.

20. The method according to claim 18,
wherein the step of calculating said estimated time for migrating a particular volume further includes:
calculating an estimated busy rate for the first array group and basing the estimated time for migrating at least in part upon maintaining the busy rate for the first array group below a maximum allowable busy rate threshold.
